(19) United States
(12) Patent Application Publication
(10) Pub. No.: US 2009/0268606 A1
(43) Pub. Date: Oct. 29, 2009

(54) METHOD AND APPARATUS FOR DETECTING AND CORRECTING FAULTS IN A SESSION INITIATION PROTOCOL (SIP) NETWORK

(76) Inventors: David A. DeLew, Rohnert Park, CA (US); Thomas H. Zabatta, Santa Rosa, CA (US); Slamet E. Swasono, Rohnert Park, CA (US); Bernadus F. Egberts, Petaluma, CA (US); Robert S. Larvenz, Rohnert Park, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/111,935

(22) Filed: Apr. 29, 2008

(51) Int. Cl. H04L 12/26

(52) U.S. Cl. 370/216

(57) ABSTRACT

Malfunctions in a communications network may introduce an unacceptably low level of reliability for many users, thereby slowing further adoption of Internet Protocol (IP) telephony, for example. In an example embodiment of the present invention, a method and corresponding apparatus for supporting a call in a presence of a fault in a network is provided. The method includes supporting a primary protocol to service a call between near-end and far-end access nodes associated with two or more callers. Signaling information in the primary protocol supporting the call may be identified and used to establish a backup protocol between the near-end and far-end access nodes. The primary protocol may be monitored for a fault and, in an event a fault occurs, supporting the call using the backup protocol. As a result, IP telephony may be transported in a more reliable manner, thereby reducing the number of dropped and uncompleted calls.

### BACKGROUND OF THE INVENTION

The popularity and convenience of Internet communications, as well as an increasing availability of broadband Internet connections, has resulted in a transformation of existing applications and services. Migration of traditional Public Switched Telephone Networks (PSTN) to Internet Protocol (IP) telephony is one such example. Also known as Voice Over IP (VoIP), IP telephony can provide real-time delivery of voice, video, and other multimedia content (herein collectively “data”), across a network using IP. Voice information is converted into packets and transmitted between or among users over an IP network, effectively allowing telephone calls to be made over the Internet.

IP telephony offers a number of advantages over PSTN networks, such as reduced costs and new features due to convergence of voice and data. However, in order for IP telephony to continue to displace PSTN service, it must have the same high reliability that users of traditional PSTN systems have come to expect.

IP telephony is session-based rather than connection based as used in PSTN systems. A signaling protocol, such as Session Initiation Protocol (SIP), may be used to create, modify, and terminate sessions with one or more participants. Sessions may include IP telephone calls, multimedia conferences, and multimedia distribution. Participants can be people or automation components, such as a voicemail server. Because SIP is an application layer protocol, it is transparent to the underlying data link layer.

IP telephony traffic is often carried over high-speed networks, such as a passive optical network (PON). PONs have emerged as a popular network architecture owing to their compelling economic advantages over other network architectures. In addition, a PON's point-to-multipoint architecture has a significant density advantage over point-to-point copper connections used with traditional PSTN systems.

A PON system can malfunction in a way such that the system may not be able to complete a new voice call, or inadvertently terminate in session calls. Existing error detection techniques, such as those described in various PON protocol standards, may not detect this type of malfunction or, if detected (e.g., generic system failure message), may not be identified. These types of malfunctions may introduce an unacceptably low level of reliability for many users thereby slowing further adoption of IP telephony.

### SUMMARY OF THE INVENTION

A method and corresponding apparatus for supporting a call in a presence of a fault in a network according to an example embodiment of the invention may support a communications protocol among multiple communications protocols to service a call between near-end and far-end communications devices. The example method may identify parameters of the call in a primary protocol and instantiate a backup protocol between a near-end access node and a far-end access node associated with the communications devices based on at least one of the parameters. The example method may further monitor the primary protocol for a fault and, in an event of a fault, support the call using the backup protocol.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of a Passive Optical Network (PON) employing an example embodiment of the invention;

FIG. 2 is a block diagram of an example portion of a network employing an example embodiment of the invention;

FIG. 3 is a more detailed block diagram of a portion of a network employing an example embodiment of the invention;

FIG. 4 is a flow diagram performed in accordance with an example embodiment of the invention;

FIGS. 5-7 are flow diagrams illustrating procedures performed in accordance with an example embodiment of the invention; and

FIG. 8 is a block diagram of the internal structure of a computer in which example embodiments of the invention may be implemented.

### DETAILED DESCRIPTION OF THE INVENTION

A description of example embodiments of the invention follows.

Network service providers are increasingly deploying fiber optic transmission media deeper and deeper into the network infrastructure. As a result, fiber-optic media is beginning to replace copper twisted pair media in many applications. For example, communications signals formerly transmitted across copper wires are now transmitted across a fiber-optic media. Consequently, new applications such as Voice over Internet Protocol (VoIP) are becoming increasingly commonplace. Although VoIP is attractive from a feature and price point of view, continued acceptance requires, in part, the same high reliability which users have become accustomed to with respect to traditional switching networks.

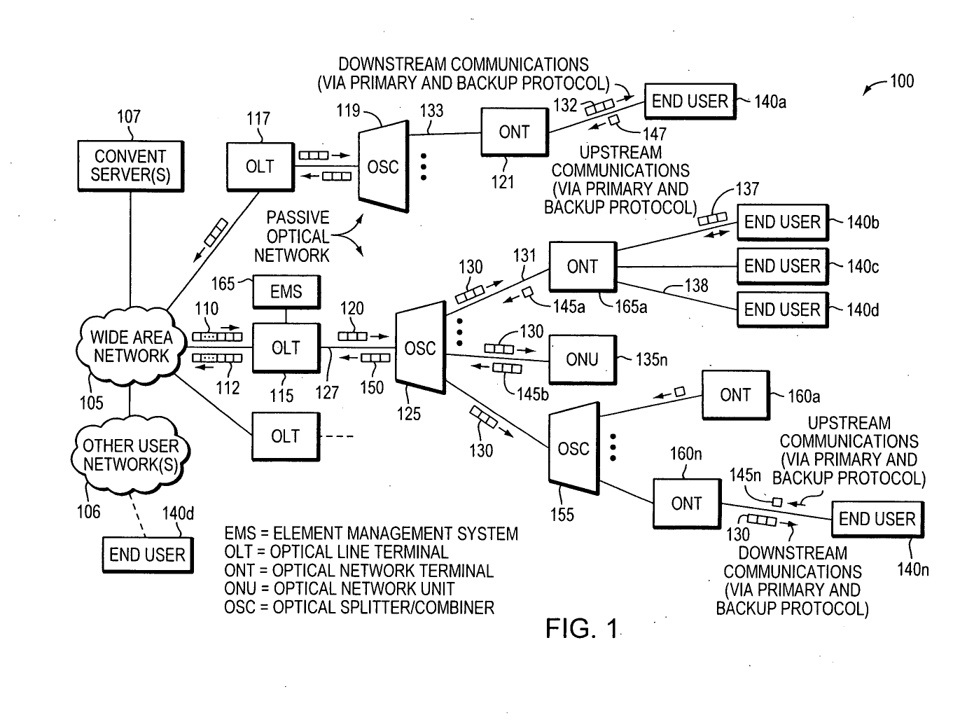

FIG. 1 is a network diagram 100 depicting aspects of an example embodiment of the invention illustrating a signaling protocol for use with VoIP communications for creating, modifying, and terminating sessions between one or more participants. Example protocols include session initiation protocol (SIP), described in IETF RFC 3261, “SIP: Session Initiation Protocol,” June 2002, http://www.ietf.org/rfc/rfc3261.txt, International Telecommunication Union-Telecommunication Standardization Sector (ITU-T) Recommendation H.323, “Packet-based multimedia communication systems,” November 2000, and ITU-T Recommendation H.225, “Call signaling protocols and media stream packetization for packet-based multimedia communication systems,” November 2000, all of which are incorporated herein by reference in their entirety.

A typical Passive Optical Network (PON) 100 includes an optical line terminal (OLT) 115, a passive optical splitter/combiner (OSC) 125, and at least one optical network node, such as an optical network terminal (ONT) 135a-n or an optical network unit (ONU) 160a-n. The PON may also include an element management system (EMS) in communication with, for example, the OLT 115. Note that as used herein, an ONU and an ONT may be used interchangeably unless indicated otherwise. Further note that “Data” as used herein refers to voice, video, analog, or digital data. The ONT 135a-n may be in optical communication with multiple end users 140a-n. Data communications 110 may be transmitted to the OLT 115 from a wide area network (WAN) 105. Content server(s) 107 or other user networks 106 provide communications signals to and from the WAN 105.

A SIP telephone network may be implemented using, in part, a PON 100. In the PON 100, communication of downstream data 120 and upstream data 150 transmitted between the OLT 115 and the ONTs 135a-n may be performed using standard communications protocols known in the art. For example, multicast may be used to transmit the downstream data 120 from the OLT 115 to the ONTs 135a-n, and time division multiple access (TDMA) may be used to transmit the upstream data 150 from an individual ONT 135a-n back to the OLT 115. Note that the downstream data 120 is power divided by the OSC 125 into downstream data 130 matching the downstream data 120 “above” the OSC 125 but with power reduced proportionally to the number of paths onto which the OSC 125 divides the downstream data 120. It should be understood that the term downstream data (e.g., downstream data 120, 130) refers to optical traffic signals that travel from the OLT 115 to the ONT(s) 135a and end user(s) 140a-n, and “upstream data” (e.g., upstream data 145a, 150) refers to optical traffic signals that typically travel from the end users 140a-n and ONTs 135a-n to the OLT 115 via optical communications paths, such as optical fiber links 131, 127, and in some networks, link 135.

The PON 100 may be deployed for fiber-to-the-premise (FTTP), fiber-to-the-curb (FTTC), fiber-to-the-node (FTTN), and other fiber-to-the-X (FTTX) applications. The optical fiber 127 in the PON may operate at bandwidths such as 155 megabits per second (Mbps), 622 Mbps, 1.25 gigabits per second (Gbps), and 2.5 Gbps or other bandwidth implementations. The PON may incorporate asynchronous transfer mode (ATM) communications, broadband services such as Ethernet access and video distribution, Ethernet point-to-multipoint topologies, and native communications of data and time division multiplexing (TDM) formats or other communications suitable for a PON. End users 140a-n may receive and provide communications from and to, respectively, the PON and may be connected to Internet Protocol telephones, video devices, Ethernet units, digital subscriber lines, computer terminals, wireless access, as well as any other conventional customer premise equipment.

The OLT 115 generates, or passes through, downstream communications 120 to an OSC 125. After flowing through the OSC 125, the downstream communications 120 are transmitted as power reduced downstream communications 130 to the ONTs 135a-n, where each ONT 135a-n may filter and replicate data 130 intended for a particular end user 140a-c. The downstream communications 120 may also be transmitted to, for example, another OSC 155 where the downstream communications 120 are again split and transmitted to additional ONT(s) 160a-n and end user(s) 140n.

Data communications 137 may further be transmitted to and from, for example, end user(s) 140a-n in the form of voice, video, data, and/or telemetry over copper, fiber, or other suitable connection 138 as known to those skilled in the art. The ONTs 135a-n may transmit upstream communication signals 145a-n back to the OSC 125 via fiber connections 133 using transmission protocols known in the art, such as Internet Protocol (IP) enabling applications such as VoIP. The OSC 125, in turn, combines the ONT's 135a-n upstream signals 145a-n and transmits a combined signal 150 back to the OLT 115 which may, for example, employ a time division multiplex (TDM) protocol to determine from which ONTs 135a-n portions of the combined signal 150 are received. The OLT 115 may further transmit the communication signals 112 to a WAN 105, back downstream to other ONTs connected to the OLT, or both.

Communications between the OLT 115 and the ONTs 135a-n occur using a downstream wavelength, for example 1490 nanometer (nm), and an upstream wavelength, for example of 1310 nm. The downstream communications 120 from the OLT 115 to the ONTs 135a-n may be provided at 2.488 Gbps, which is shared across all ONTs. The upstream communications 145a-n from the ONTs 135a-n to the OLT 115 may be provided at 1.244 Gbps, which is shared amongst all ONTs 135a-n connected to the OSC 125. Other communication data rates known in the art may also be employed.

Communications between end users 140a-n may travel across multiple PONs and multiple networks 105, 106. For example, another PON 100, such as that represented by OLT 117, OSC 119, and ONT 121, may be connected to the WAN 105 or to other user networks 106 and may operate in a manner similar to that described above with respect to OLT 115, OSC 125, ONTs 135a-n, and end users 140a-n. Thus, communications may travel between end users within the same PON or may traverse multiple PONs and/or networks.

A SIP network may be enhanced by providing error detection and backup connection techniques in an event errors are detected. A phone call between two or more users, for example, End Users 140a and 140n, may be supported using downstream communications 130, 132 and upstream communications 145n, 147 via a primary protocol. The ONT(s) 121, 160n associated with the End Users 140a, 140n may be configured to identify call parameters in the primary protocol and, based on the parameter, instantiate a backup protocol between the End Users 140a, 140n. The primary protocol may be monitored for faults, and in the event a fault occurs, the called can be switched to the backup protocol, thereby preventing the call from being dropped.

Instantiating a backup protocol is defined herein as creating, modifying, and terminating sessions with one or more participants such as is described in Request For Comments (RFC) 3261, “SIP: Session Initiation Protocol,” June 2002, incorporated herein by reference in its entirety. These sessions include Internet telephone calls, multimedia distribution, and multimedia conferences.

An example method and corresponding apparatus for supporting a communications protocol among multiple communications protocols to service a call between near-end and far-end communications devices may include identifying parameters (e.g., source or destination identification (ID)) of the call in a primary protocol. The example method may include instantiating a backup protocol between a near-end access node and a far-end access node associated with the communications devices based on at least one of the parameters. The example method may further include monitoring the primary protocol for a fault and, in an event of a fault, support the call using the backup protocol. Example communications protocols may include ATM adaptation layer 1 (AAL1), AAL2, TDM, ATM, Internet protocol (IP), wireless, or similar such protocols known in the art. Example network nodes may include an ONT, ONU, or OLT.

An alternative embodiment may further include identifying the far-end source ID of an incoming call or destination ID of an outgoing call and providing the ID to disable a ‘call busy state’ to enable instantiation of the backup protocol to support caller ID blocking. A unique identifier may be used to identify the source ID or destination ID. Identifying parameters of the call may also include parsing Session Initiation Protocol (SIP) packets to identify the parameters of a call, including a source ID or destination ID using at least one of the following identifiers: a media access control (MAC) address, IP address, or telephone number

In another example embodiment, the technique may further include configuring the primary and backup protocols prior to establishing the call via the primary protocol. The backup protocol may be instantiated after establishing the call via the primary protocol. In this way, the backup protocol may be activated prior to a call being inadvertently dropped. The example embodiment may further include reestablishing the call via the backup protocol after a drop of the call. The active protocol may use a SIP where a “ping” rate on the SIP is increased to determine its availability in order to reestablish the call via the primary protocol. The primary protocol may be monitored while the call is being serviced by the backup protocol, and if the primary protocol becomes available again during the call, the call may be returned to the primary protocol.

In yet another example embodiment, identifying parameters may include identifying a call priority identifier among the identified parameters, such that a 911 call, enhanced 911 call, or emergency service call may be recognized. The technique may further include determining service usage fees based on instantiating the backup protocol or supporting the call using a backup protocol.

In still another example embodiment, a computer program product may be used to support a call in a network where the computer program product includes a computer readable medium having computer readable instructions stored thereon, which, when loaded and executed by a processor, cause a processor to support any combination of the foregoing procedures.

It should be noted that a call may refer to a traditional telephone voice call, but should not be viewed as limited to such, and may also include transmission of any variety of multimedia content such as video, audio, multimedia conferencing, gaming, distant education, and the like.

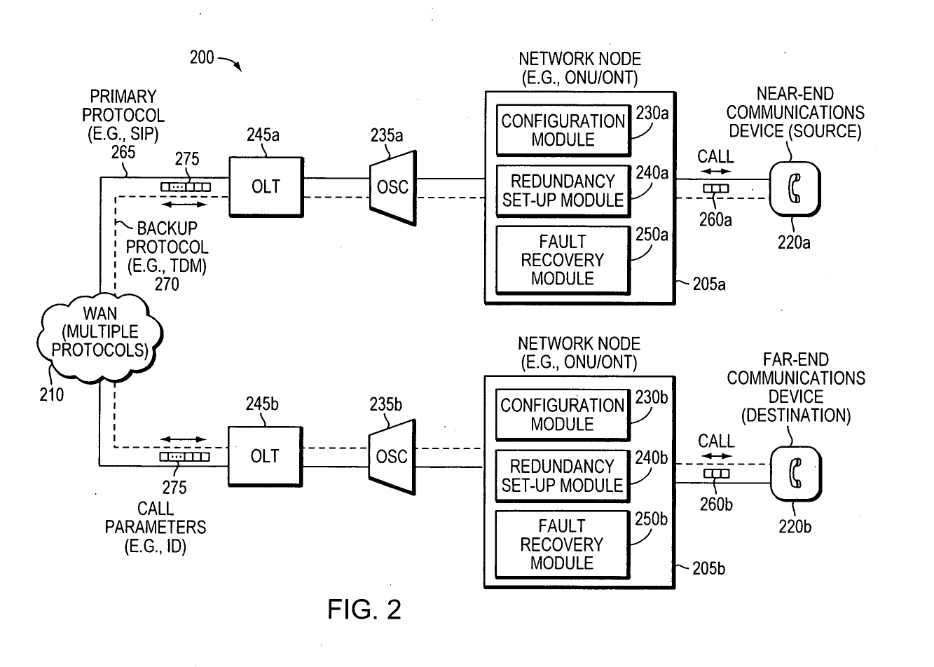

FIG. 2 is a block diagram of a SIP telephone network 200 configured to support communications such as a telephone call 260a-b between at least one near-end communications device 220a and at least one far-end communications device 220b according to an example embodiment of the invention. The network 200 may include one or more PONs connected to a WAN 210. The WAN 210 may support multiple communications protocols such as AAL1, AAL2, TDM, ATM, IP, various wireless protocols, or similar such protocols known in the art. The WAN 210 may also include other networks (not shown) such that the call 260a-b travels across multiple networks. A call 260a-b between two communications devices 220a-b takes place in the form of downstream communications and upstream communications as was described with reference to FIG. 1.

The network nodes 205a-b include communications modules 230a-b, redundancy set-up modules 240a-b, and fault recovery modules 250a-b. The communications modules 230a-b are configured to support a communications protocol from among multiple communications protocols to service the call between the near-end and far-end communications devices 220a-b. A primary protocol 265 may be initially used to service the call 260a-b. The redundancy set-up module 240a-b identifies parameters 275 of the call 260a-b in the primary protocol 265, such as a source ID or destination ID. Based on the identified parameters 275, the redundancy set-up module 240a-b also instantiates a backup protocol 270 between the near-end device 220a and the far-end device 220b, thus, effectively providing a backup connection for the call 260a-b. The fault recovery module 250a-b may be used to monitor the primary protocol 265 for a fault. In the event a fault occurs with the primary protocol 265, the backup protocol 270 may be used to continue supporting the call 260a-b, thereby transparently preventing call termination and providing an additional level of reliability. It should be understood that the redundancy set-up modules 240a-b and fault recovery modules 250a-b can be configured to operate independently or in a cooperative manner, such as through an exchange of state information or signaling procedure.

In an alternative embodiment, the backup protocol 270 may be initially used to service the call 260a-b. For example, if the primary protocol is 265 designated to be the default communications protocol and that protocol is unavailable, the backup protocol may be initially used to make any subsequent calls 260a-b. The primary protocol 265 may be monitored, and should it become available, the call 260a-b may be switched back to the primary protocol 265.

The one or more PON(s) 200 may include an OLT 245a-b, OSC 235a-b, and network node 205a-b, such as an ONT. In a case where the near-end communications device 220a and the far-end communications device 220b are within the same PON (e.g., ultimately connected to the same OLT), the call may take place within the same PON, and traverse the same physical link within that PON. However, if the communications devices 220a-b are not within the same PON (i.e., not connected to the same OLT), at least two PONs may be used conduct the call 260a-b, as is the case depicted in FIG. 2. In this case, the call may or may not traverse the same physical link.

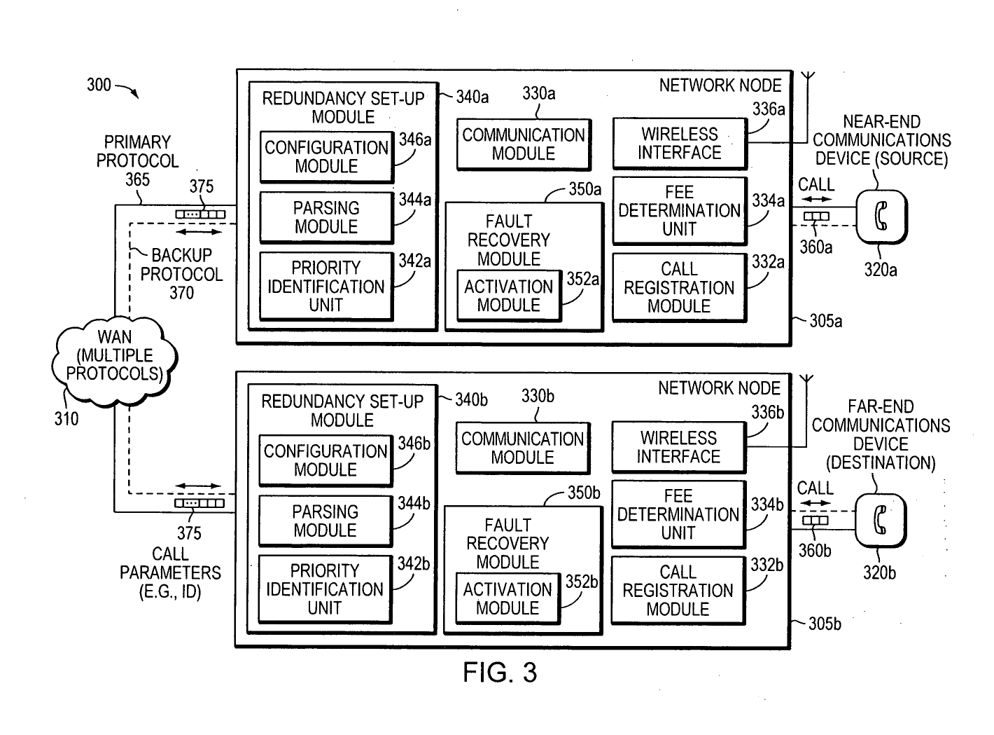

FIG. 3 is a more detailed block diagram of the SIP telephone network 300 depicted in FIG. 2. The network includes near-end and far-end communication devices 320a-b, network nodes 305a-b, and a network such as a WAN 310. Note that a SIP telephone network 300 may be configured, in part, as one or more PONs as was shown in FIG. 2 and as discussed above; however, in FIG. 3, the OSC and OLT have been omitted for the sake of brevity.

In an example embodiment, the network node 305a-b may be, for example, an ONT and may include a redundancy set-up module 340a-b, communications module 330a-b, fault recovery module 350a-b, call registration module 332a-b, fee determination unit 334a-b, and wireless interface 336a-b. The redundancy set-up module 340a-b may further include a configuration module 346a-b, parsing module 344a-b, and priority identification unit 342a-b. The fault recovery module 350a-b may further include an activation module 352a-b.

In this embodiment, a call 360a-b may, for example, be initiated by a user at the near-end communications device 320a to a user at the far-end communications device 320b. The call registration module 332a associated with the near-end communications device 320a (i.e., caller) may identify the destination ID of the far-end communications device 320b (i.e., callee). Upon receiving the call 360b at the callee's network node 305b, the call registration module 332b associated with the far-end communications device 320b may identify a call parameter, such as a source ID of the calling device.

Traditional telephone calls typically do not allow more than one simultaneous connection per call. In the event a second call is received while another call is in progress, a call busy state is indicated. To enable both primary and backup connections simultaneously, in one example embodiment, the call registration module 332a-b provides the source and destination ID to the redundancy set-up module 340a-b in order to disable a “call busy state” in order to enable instantiation of the backup protocol 370 to support caller ID blocking.

The parsing module 344a-b may be used to parse packets to identify various call parameters 375. For example, the parsing modules 344a-b may be used to parse SIP packets to identify a call parameter 375, such as a MAC address, IP address, telephone number, or other such identifier, and may associate a unique identifier with a corresponding source ID or destination ID.

Continuing to refer to FIG. 3, the configuration module 346a-b may be used to configure the primary protocol 365 and backup protocol 370 for the call 360a-b. The primary protocol 365 and backup protocol 370 may be configured prior to establishing the call via, for example, the primary protocol. The primary protocol 365 and backup protocol 370 may use various communications protocols, such as, for example, AAL1, AAL2, SIP, TDM, ATM, TDM, ATM, IP, or similar such protocols. In addition, or alternatively, the wireless interfaces 336a-b may be used to enable use of various wireless protocols, such as TDMA, code division multiple access (CDMA), global system for mobile communications (GSM), or similar wireless protocols known in the art.

After the call 360a-b has been established using the primary protocol 365, the configuration module 346a-b may instantiate the backup protocol 370, thus, providing a backup connection for the call 360a-b. After the backup protocol 370 has been instantiated, the activation module 352a-b may activate the backup protocol 370 at any time in order to provide a seamless transition between protocols. That is, because the call 360a-b effectively maintains two simultaneous connections (i.e., primary and backup protocol), in the event the primary connection is dropped, the activation module 352a-b may reestablish the call via the backup protocol 370.

While the call 360a-b is being maintained by the backup protocol 370, the activation module 352a-b may also be configured to monitor the primary protocol 365 and, in the event the primary protocol 365 becomes available during the call 360a-b, the call 360a-b may be switched back or returned to the primary protocol 365. For example, if the primary protocol 365 uses SIP, the activation module 352a-b may increase a ping rate on the SIP to determine its availability in order to reestablish the call via the primary protocol 365.

The ability to monitor the primary protocol 365 while the backup protocol 370 is being used to support the call 360a-b may be advantageous in the situation where the primary protocol 365 and backup protocol 370 are associated with different usage fees. For example, calls 360a-b serviced using a SIP protocol may be less expensive than calls using, for example, an ATM protocol. Thus, a more expensive backup protocol may be used only when necessary. In addition, the network node 305a-b may also include a fee determination unit 334a-b that may be used to determine service usage fees based on instantiation or support of the call 360a-b using the backup protocol 370.

The priority identification unit 342a-b may also identify a call priority identifier among the call parameters 375. For example, the call priority identifier may represent or be associated with a 9-1-1 call, enhanced 9-1-1 calls, or similar such emergency call. Enhanced 9-1-1 refers to the an emergency calling system that automatically associates a physical address with a calling party's telephone number. The priority identification unit 342a-b may also be configured to undertake further action based on the identified call priority.

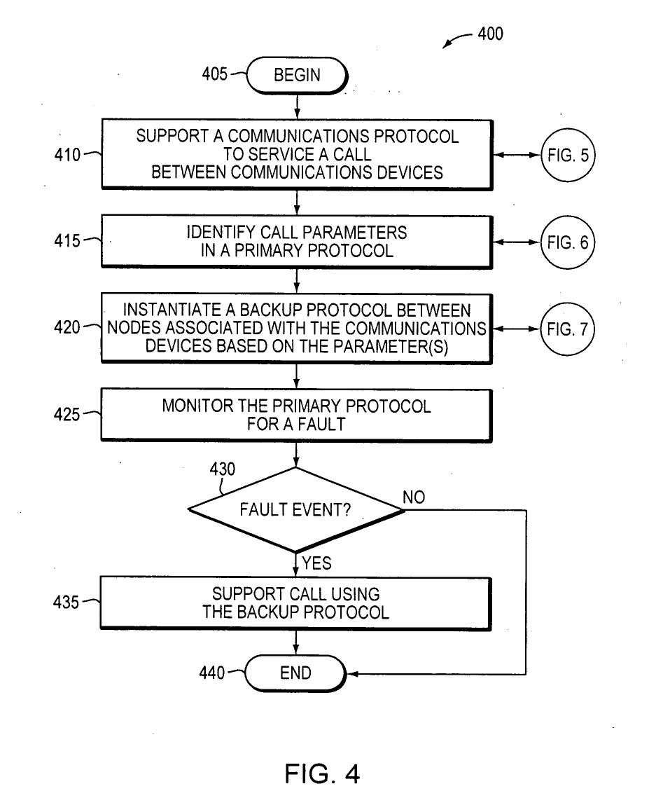

FIG. 4 illustrates, in the form of a flow diagram, an example embodiment of the present invention. It should, however, be evident that various modifications and changes may be made thereto without departing from the broader spirit and scope of the example embodiment. For example, some of the flow diagrams presented herein, including FIG. 4, may be performed in an order other than that which is described. It should be appreciated that not all of the flow diagrams are required to be performed, that additional flow diagram(s) may be added, and that some may be substituted with other flow diagram(s).

The procedure 400 depicted in FIG. 4 begins (405) and supports a communications protocol from among multiple protocols to service a call between at least two communications devices (410). The procedure 400 may identify call parameters in a primary protocol (415). The procedure 400 may then instantiate a backup protocol between at least two access nodes associated with the at least two communications devices based on the identified call parameters (420). After the primary protocol and backup protocol have been established, the procedure may monitor the primary protocol for a fault (425). In the event of a fault (430), the procedure may support the call using the backup protocol (435). The procedure may end (440) when, for example, the calling parties terminate the call.

Some or all of the steps in the procedure 400 may be implemented in hardware, firmware, or software. If implemented in software, the software may be (i) stored locally with the OLT, ONT, End User communications device, or some other remote location such as a server or the EMS, or (ii) stored remotely and downloaded to the OLT, ONU, End User communications device, or the EMS during, for example, start 405. The software may also be updated locally or remotely. To begin operations in a software implementation, the OLT, ONU, End User communications device, or EMS loads and executes the software in any manner known in the art.

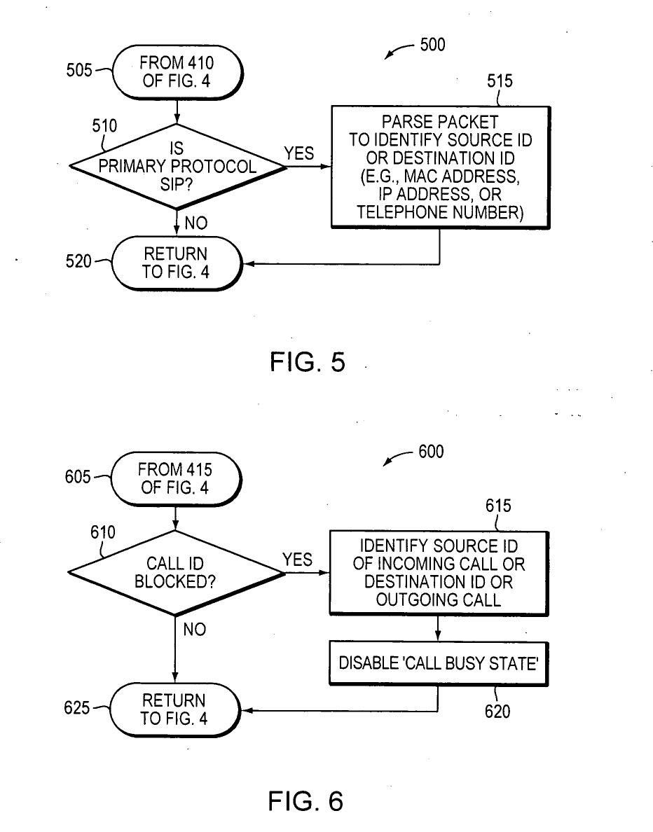

FIG. 5 is a flow diagram of a procedure 500 illustrating an alternative example embodiment of the procedure described with reference to FIG. 4. In this embodiment, support of a communications protocol to service a call between communications devices (505) may include determining if the primary protocol uses a SIP protocol (510). If not, the procedure returns (520) to FIG. 4. If a SIP protocol is in use, the procedure may parse packets to identify particular call parameters (515), such as a MAC address, IP address, telephone number, or the like. These parameters may be used to associate a unique identifier with a particular communications device or access node. The procedure then returns (520) to FIG. 4. In an alternative embodiment, the same procedure may be used except that a backup protocol is examined for use of a SIP protocol.

FIG. 6 is a flow diagram of a procedure 600 according to another alternative example embodiment. In this embodiment, identifying call parameters in a primary protocol (605) may further include determining if, for example, a call's caller ID is blocked (610). If not, the procedure returns (625). If caller ID is blocked (610), the procedure may identify a source ID of an incoming call or destination ID of an outgoing call (615) and disable a call busy state (620). The procedure then returns (625) to FIG. 4.

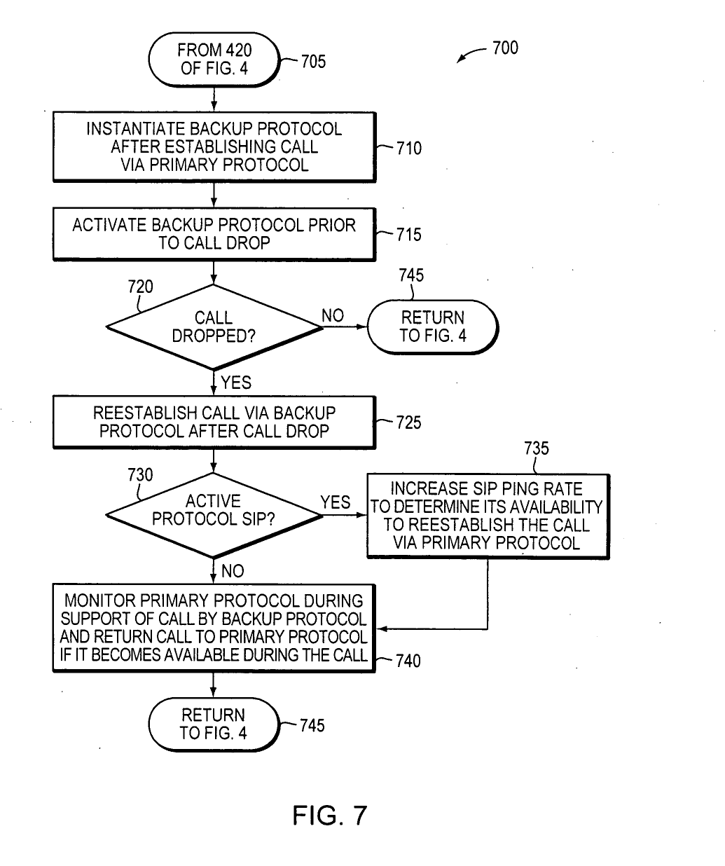

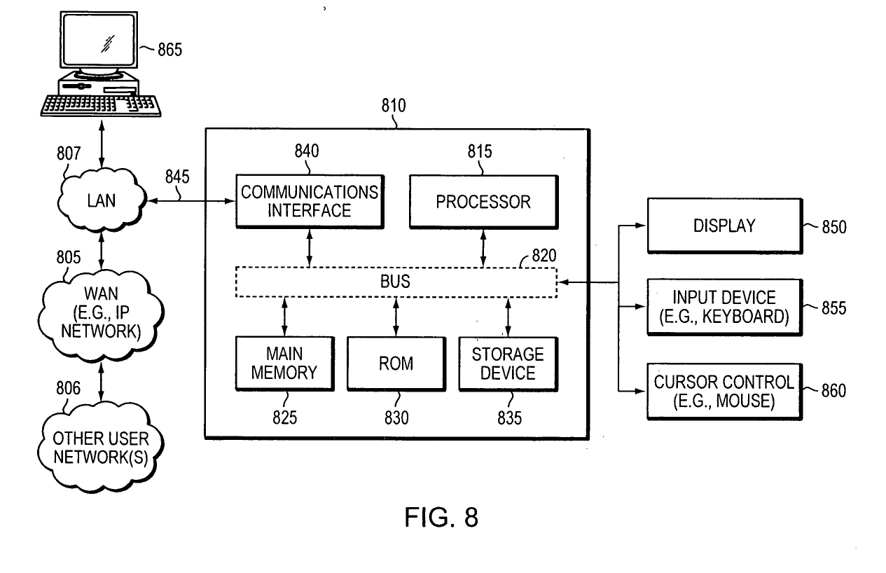

FIG. 7 is a flow diagram of a procedure 700 illustrating yet another alternative embodiment. The procedure 700 may instantiate the backup protocol after establishing the call via the primary protocol (710). After the backup protocol and been instantiated, it may be activated prior to a call being dropped (715), thereby providing a redundant connection. The procedure 700 may determine if an established call has been dropped (720) and, if not, the procedure 700 returns (745) to FIG. 4. If the call is dropped from the primary protocol, the call may be reestablished via the backup protocol (725).

The procedure 700 may determine if the active protocol uses SIP (730) and, if so, the procedure 700 may increase the SIP's ping rate to determine its availability for the purpose of, for example, reestablishing the call via the primary protocol (735). For example, in the situation where SIP is the primary protocol and TDM/ATM is the backup protocol, and due to an error of some sort, the call is switched to the backup protocol. The procedure may increase the SIP's ping rate (e.g., increasing the rate to 1 second) such that when the primary protocol becomes available, the call may be switched back to use the SIP.

The procedure 700 may continue to monitor the primary protocol during support of the call by the backup protocol and, in the event the primary protocol becomes available to call, support of the call may be returned to the primary protocol (740). The process 700 may then return (745).

It should be readily appreciated by those of ordinary skill in the art that the aforementioned procedures are merely exemplary and that the example embodiments are in no way limited to the number of actions or the ordering of steps described above.

In another alternative example embodiment where the primary protocol uses a SIP, the SIP network may be configured to implement “keep alive” messages at a non-standard rate. For example, rather than a standard rate of say 10 minutes, the keep alive message rate may be increased to 1 second such that the messages cover the entire span of an active call from one device associated with an ONT to another device associated with another ONT. This much finer level of granularity allows the ONT to determine error conditions quickly. The ONT may further report an alarm and/or initiate corrective action.

In this embodiment, if both ONT's have access to the same backup protocol (e.g., TDM/ATM), a backup protocol may be instantiated and activated in less time that it takes for a call to be dropped. Consequently, the backup protocol is provided only when the primary protocol becomes problematic. That is, the primary and backup protocols do not need to be simultaneously available. For example, consider a SIP network where each ONT uses SIP as the primary protocol and each ONT has access to the same backup protocol (e.g., TDM). In the event a problem occurs with the primary protocol (i.e., SIP), the primary protocol can be abandoned, and the originating ONT can automatically call the other ONT(s) using the backup protocol via a TDM/ATM network using an AAL1 or AAL2 connection.

In the event there are no problems with the primary protocol, the backup protocol need not be enabled. Furthermore, if a call is not in progress and the SIP network is not available, the ONT may initiate new calls using the backup TDM network until the SIP network is restored.

Although the apparatus and method described herein discuss transporting downstream and upstream communications signals using a fiber optic media in a PON, the example embodiments are not meant to be limited to such a media or network architecture. It should be understood that the example embodiments can be implemented, in part, or in its entirely, using alternative physical media such a coaxial (or similar) wire such as a cable media commonly used to deliver television, VoIP, and/or Internet services to an end user's premise.

Further, the Sessions Initiation Protocol as well as the instructions to transmit and receive SIP messages may reside on a computer-readable medium. The term “computer-readable medium” as used herein refers to any medium that participates in providing instructions to processor for execution. Such a medium may take many forms, including but not limited to, non-volatile media, volatile media, and transmission media. Non-volatile media includes, for example, optical or magnetic disks, such as storage device. Volatile media includes dynamic memory, such as main memory. Transmission media includes fiber optics, copper wires and coaxial cables, including the wires that comprise bus. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, or any other optical medium, RAM, PROM, EPROM, FLASH, or any other memory chip or cartridge, a carrier wave as described hereinafter, or any other medium from which a computer can read.

While this invention has been particularly shown and described with references to example embodiments thereof, it will be understood by those skilled in the art that various changes in form and details may be made therein without departing from the scope of the invention encompassed by the appended claims.

What is claimed is:

1. A network node, comprising:
a communications module configured to support a communications protocol among multiple communications protocols to service a call between near-end and far-end communications devices;
a redundancy set-up module to identify parameters of the call in a primary protocol and instantiate a backup protocol between a near-end access node and a far-end access node associated with the communications devices based on at least one of the parameters; and
a fault recovery module to monitor the primary protocol for a fault and, in an event of a fault, support the call using the backup protocol.

2. The network node according to claim 1 wherein the parameters include a source identification (ID) or destination ID.

3. The network node according to claim 1 further comprising a call registration module configured to identify the far-end source ID of an incoming call or destination ID of an outgoing call and provide the ID to the redundancy set-up module to disable a ‘call busy state’ to enable instantiation of the backup protocol to support caller ID blocking.

4. The network node according to claim 3 wherein the call registration module is further configured to use a unique identifier to identify the source ID or destination ID.

5. The network node according to claim 1 wherein the redundancy set-up module includes a parsing module to parse Session Initiation Protocol (SIP) Packets to identify the parameters of a call, including a source or destination ID having at least one of the following identifiers: MAC address, IP address, or telephone number.

6. The network node according to claim 1 wherein the communications protocols include at least one of the following: AAL1, AAL2, TDM, ATM, IP, or wireless.

7. The network node according to claim 1 wherein the network node is an optical network terminal (ONT) or an optical line terminal (OLT) in a passive optical network (PON).

8. The network node according to claim 8 wherein the network node includes a wireless interface and wherein the backup protocol includes a wireless protocol.

9. The network node according to claim 1 wherein the redundancy set-up module includes a configuration module to configure the primary and backup protocols prior to establishing the call via the primary protocol.

10. The network node according to claim 1 wherein the redundancy set-up module includes a configuration module to instantiate the backup protocol after establishing the call via the primary protocol.

11. The network node according to claim 1 wherein the fault recovery module includes an activation module to activate the backup protocol prior to a drop of the call.

12. The network node according to claim 1 wherein the fault recovery module includes an activation module configured to reestablish the call via the backup protocol after a drop of the call.

13. The network node according to claim 12 wherein the primary protocol uses a SIP and wherein the activation module is configured to increase a ping rate on the SIP to determine its availability to reestablish the call via the primary protocol.

14. The network node according to claim 1 wherein the fault recovery module includes an activation module configured to monitor the primary protocol during support of the call by the backup protocol and return the call to the primary protocol if it becomes available again during the call.

15. The network node according to claim 1 wherein the redundant set-up module further includes a priority identification unit configured to identify a call priority identifier among the parameters and to take action based on the call priority identifier.

16. The network node according to claim 15 wherein the call priority identifier is representative of at least one of the following: a 9-1-1 call, enhanced 9-1-1 call, or emergency service call.

17. The network node according to claim 1 further including a fee determination unit configured to determine service usage fees based on an instantiation of the backup protocol or support of the call using a backup protocol.

18. A method to support a call in a presence of a fault in a network, the method comprising:
supporting a communications protocol among multiple communications protocols to service a call between near-end and far-end communications devices;
identifying parameters of the call in a primary protocol;
instantiating a back-up protocol between a near-end access node and a far-end access node associated with the communications devices based on at least one of the parameters; and
monitoring the primary protocol for a fault and, in an event of a fault, supporting the call using the backup protocol.

19. The method according to claim 18 wherein the parameters include a source identification (ID) or destination ID.

20. The method according to claim 18 further including identifying the far-end source ID of an incoming call or destination ID of an outgoing call and providing the ID to disable a ‘call busy state’ to enable instantiation of the backup protocol to support caller ID blocking.

21. The method according to claim 20 further including using a unique identifier to identify the source ID or destination ID.

22. The method according to claim 18 wherein identifying parameters of the call includes parsing Session Initiation Protocol (SIP) packets to identify the parameters of a call, including a source ID or destination ID having at least one of the following identifiers: MAC address, IP address, or telephone number.

23. The method according to claim 18 wherein the communications protocols include at least one of the following: AAL1, AAL2, TDM, ATM, IP, or wireless.

24. The method according to claim 18 wherein the network node is an optical network terminal (ONT) or an optical line terminal (OLT) in a passive optical network (PON).

25. The method according to claim 18 wherein the backup protocol includes a wireless protocol.

26. The method according to claim 18 further including configuring the primary and backup protocols prior to establishing the call via the primary protocol.

27. The method according to claim 18 wherein instantiating the backup protocol includes instantiating the backup protocol after establishing the call via the primary protocol.

28. The method according to claim 18 further including activating the backup protocol prior to a drop of the call.

29. The method according to claim 18 further including reestablishing the call via the backup protocol after a drop of the call.

30. The method according to claim 29 wherein the active protocol uses a SIP and further including increasing a ping rate on the SIP to determine its availability to reestablish the call via the primary protocol.

31. The method according to claim 18 further including monitoring the primary protocol during support of the call by the backup protocol and returning the call to the primary protocol if it becomes available again during the call.

32. The method according to claim 18 wherein identifying parameters includes identifying a call priority identifier among the parameters.

33. The method according to claim 32 wherein the call priority identifier is indicative of at least one of the following: a 9-1-1 call, enhanced 9-1-1 call, or emergency service call.

34. The method according to claim 18 further including determining service usage fees based on instantiating the backup protocol or supporting the call using a backup protocol.

35. A computer program product for supporting a call in a presence of a fault in a network, the computer program product comprising a computer readable medium having computer readable instructions stored thereon, which, when loaded and executed by a processor, cause the processor to:
support a communications protocol among multiple communications protocols to service a call between near-end and far-end communications devices;
identify parameters of the call in a primary protocol;
instantiate a back-up protocol between a near-end access node and a far-end access node associated with the communications devices based on at least one of the parameters; and
monitor the primary protocol for a fault and, in an event of a fault, support the call using the backup protocol.
